(19) United States
(12) Patent Application Publication
(10) Pub. No.: US 2009/0157835 A1
(43) Pub. Date: Jun. 18, 2009

(54) Presence Enabled Instance Messaging for Distributed Energy Management Solutions

(75) Inventors: Jacob Thompson, Westborough, MA (US); Sean Hyrich, Peabody, MA (US); Terrence E. Sick, Rochester, NY (US); Michael Russo, Cambridge, MA (US)

Correspondence Address: BROMBERG & SUNSTEIN LLP, 125 SUMMER STREET, BOSTON, MA, 02110-1618, US

(73) Assignee: ENERNOC, INC., Boston, MA (US)

(21) Appl. No.: 12/333,960

(22) Filed: Dec. 12, 2008

Related U.S. Application Data
(60) Provisional application No. 61/013,079, filed on Dec. 12, 2007.

(51) Int. Cl. G06F 15/16

(52) U.S. Cl. 709/206; 709/227

(57) ABSTRACT

A method and system is described for real time communication in a network of distributed energy resource management devices (EMDs). Presence-based real time communications are established between at least one distributed energy resource management device (EMD) connected to an electric utility grid and a network operations center (NOC) application.

### CROSS REFERENCE TO RELATED APPLICATIONS

The present application claims priority to U.S. Provisional Application No. 61/013,079, filed Dec. 12, 2007, which application is hereby incorporated by reference herein in its entirety.

### FIELD OF THE INVENTION

The present invention generally relates to transferring and processing information for distributed energy resource management devices (EMDs) through the use of presence-based real time communications. For example, instant messaging technology (IMT) facilitates automation of tasks such as remote configuration and updates of EMDs, data acquisition, operation of total energy management solutions (TEMS) systems, and command and control of devices in a distributed energy resource (DER) network.

### BACKGROUND ART

The ability to efficiently control distributed generation and to curtail assets in response to notifications of regional power disruptions, from grid operators and utilities (commonly referred to as a demand response (DR)) plays an increasingly important role in today's energy markets. Efficiently controlling these operations requires an analysis of both distributed generation and resource consumption. One of the biggest efficiency challenges facing the industries involved in these processes relates to remote communications between utilities, grid operators, and EMDs to enable real-time response to dynamic energy usage conditions. Real-time bidirectional communication serves multiple purposes, including without limitation:
enabling utilities and grid operators to communicate with TEMS service providers to initiate and end DR events,
enabling TEMS service providers to collect data, control EMDs, facilitate site configurations and participation in DR events,
enabling TEMS service providers to communicate DR event execution status to utilities and grid operators, and
enabling TEMS service providers to communicate information regarding energy efficiency (EE) to customers.

Communications between utilities, grid operators, and TEMS service providers as well as communications between TEMS service providers and remote EMDs presently lack standardization. Many utilities, grid operators, and EMD manufacturers utilize their own standards for communicating messages and data. Furthermore, these standards often lack key features that are conducive to providing TEMS. The lack of standardization and absence of key features often requires TEMS service providers to undertake large communication related engineering efforts simply to support new EMDs and/or participate in new DR programs. Additionally, the lack of features in communication standards necessitates the implementation of certain services by TEMS service providers in both costly and technologically undesirable manners.

Reliability and security are also major concerns for communications between utilities, grid operators, and TEMS service providers as well as communications between TEMS service providers and remote EMDs. A counterfeit or missed message to or from a utility or grid operator would result in large penalties for TEMS service providers and could even cause damage to a grid. Similarly, a counterfeit or missed message to or from remote EMDs could damage customer equipment or disrupt customer operations. Furthermore, certain data exchanged between utilities, grid operators, EMDs, and TEMS service providers as well as TEMS service providers and customers is sensitive in nature and should therefore be protected via secure authorization requirements and encryption processes to prevent the interception of the data.

Another problem specific to how a TEMS service provider communicates with remote EMDs is scalability in terms of cost and complexity. Currently, cost effective bidirectional communication between EMDs and TEMS service providers necessitates polling remote EMDs at frequent intervals (e.g., five minutes or less), which requires inbound access to all remote EMDs in a distributed energy resource (DER) network. Creating inbound access for an EMD at a customer site generally requires interfacing with the site's IT department, who are often reluctant to allow third party devices to operate on their computer networks, which can either delay an installation or require alternative means of access to EMDs (such as installing a cellular gateway which not only incurs additional installation costs, but also ongoing monthly fees for wireless service, which is slower and less reliable than an Ethernet connection). Furthermore, a reliance on polling for data acquisition increases the costly processing infrastructure and algorithmic complexity TEMS service providers must have available. Additionally, many EMDs rely on serial and/or HTTP based communication for EMD configuration, and this can cause security problems in some cases and adds complexity (often in the form of site visits) to the process of troubleshooting and changing or updating a remote EMD configuration and programming.

### SUMMARY OF THE INVENTION

A communication framework built upon presence based IMT will not only address the aforementioned problems of TEMS service provider and utility/grid operator communication and scalability, but also facilitates dynamic, real-time, highly efficient and automated processes of site configuration, data collection, device control, event management, energy management, and energy procurement via encrypted messages in a reliable secure environment. Thus, embodiments of the present invention are directed to real time communication in a network of distributed energy resource management devices (EMDs). Presence-based real time communications are established between one or more distributed energy resource management devices (EMDs) connected to an electric utility grid and a network operations center (NOC) application. For example, the presence-based real time communications may be based on secure encrypted instant messaging technology (e.g., Extensible Messaging and Presence Protocol (XMPP)) implemented on an instant messaging server (IMS) for machine-to-human(s) (M2H), human-to-machine(s) (H2M), and machine-to-machine(s) (M2M) communications with instant messaging clients (IMCs) at the EMDs and the NOC.

In further specific embodiments, the presence-based real time communications may include energy management communications such as at least one of control commands, data acquisition, data reporting, event notification, energy procurement, and EMD control commands such as configuration changes, programming updates, and distributed energy resource (DER) control commands. Similarly, the EMD may be a distributed generation (DG) device.

Embodiments of the present invention also include a system for real time communication in a network of distributed energy resource management devices (EMDs) according to any of the above where there are distributed energy resource management devices (EMDs) connected to an electric utility grid and a network operations center (NOC) application having presence-based real time communications with the EMDs.

Embodiments also include a communications device for a network of distributed energy resource management devices (EMDs) according to any of the above where a local communications client for a distributed EMD connected to an electric utility grid establishes presence-based real time communications with a network operations center (NOC) application.

In further specific embodiments, the data acquired by the system can be aggregated and analyzed to determine power usage patterns from multiple sites, divisions, organizations, and groups of organizations in certain time slices, patterns of usage, load balancing options, and other scenarios to facilitate ongoing automated optimization of energy usage and acquisition cost.

### BRIEF DESCRIPTION OF THE DRAWINGS

FIG. 1 illustrates a presence-based real time IMS routing energy usage and energy management information between the components of a TEMS system in accordance with an embodiment of the present invention.

FIG. 2 illustrates an example of a presence-based real time IMS routing energy usage and energy management information during a DR event in accordance with an embodiment of the present invention.

FIG. 3 illustrates a presence-based real time IMS routing energy usage and energy management information during new DER installation and existing DER troubleshooting in accordance with an embodiment of the present invention.

### DETAILED DESCRIPTION OF SPECIFIC EMBODIMENTS

As used herein, the term “real time” refers to the ability to function and control systems and processes while operating as events occur.

As used herein, instant messaging technology (IMT) refers to as any protocol that utilizes an instant message server (IMS) or an IMS cluster to provide communications with instant message client (IMC) nodes. The IMCs initiate communication with an IMS, and this reliance on outbound connections allows IMT to avoid most firewall conflicts. Messages between IMCs and the IMS are delivered via a highly reliable transport protocol independently of the physical media of transmission, for example, by Transmission Control Protocol (TCP).

The IMS may also provide for message encryption such as by Transport Layer Security (TLS). The IMS maintains a list of credentials for all IMCs with registered accounts, and IMCs wishing to communicate on the IMS network must provide valid credentials to the IMS in a secure manner (such as by Simple Authentication and Security Layer (SASL)). IMCs without valid credentials may not be allowed to participate. The IMS may also maintain various lists for the benefit of IMCs with registered accounts, such as:
an IMC network status (or presence) list which contains the current status in terms of ability to send and receive messages (such as offline, online, or away) of all IMCs with accounts registered on the IMS, and
a IMC contact (or buddy) list (also known as a roster) for each IMC with an account registered on the IMS contains all other IMCs an IMC has added.
   These lists allow the IMS to inform IMCs of changes in presence for the members of its roster. The above core functionality is often leveraged to implement additional protocol features including but not limited to group chatting (or messages delivered to more than one IMC), IMS offline message delivery queues, and file transfer. The Extensible Messaging and Presence Protocol (XMPP) is one protocol that fits this definition. IMT is typically used to exchange messages between humans.

Controllable message routing by the IMS is a further benefit of IMT, and IMSs can be configured to support Broadcast Services. A Broadcast Service allows an IMC to send messages to a Service on the IMS (as opposed to another IMC node). Upon receipt of a message, an IMS based Broadcast Service will deliver the message to all available IMC accounts subscribed to the Broadcast Service. This facilitates a single write to be sent to multiple readers allowing efficient large scale messages distribution to all involved parties instantly. This is different than typical instant messaging arrangements where one message would have to be written for each intended IMC recipient, and from group chat where all participants are allowed to write. Broadcast Services, in which only the controlling entity can send a message to the readers, decrease the amount of traffic sent between IMCs and simplify Roster management.

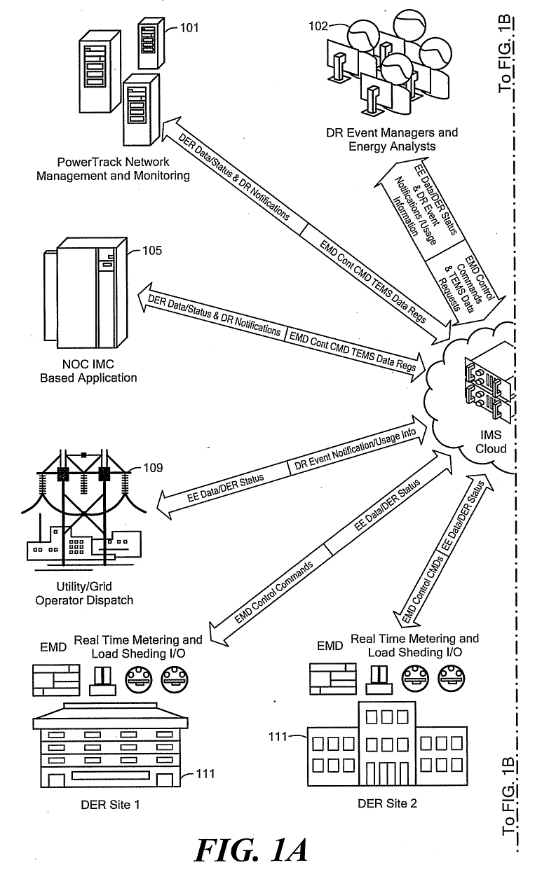

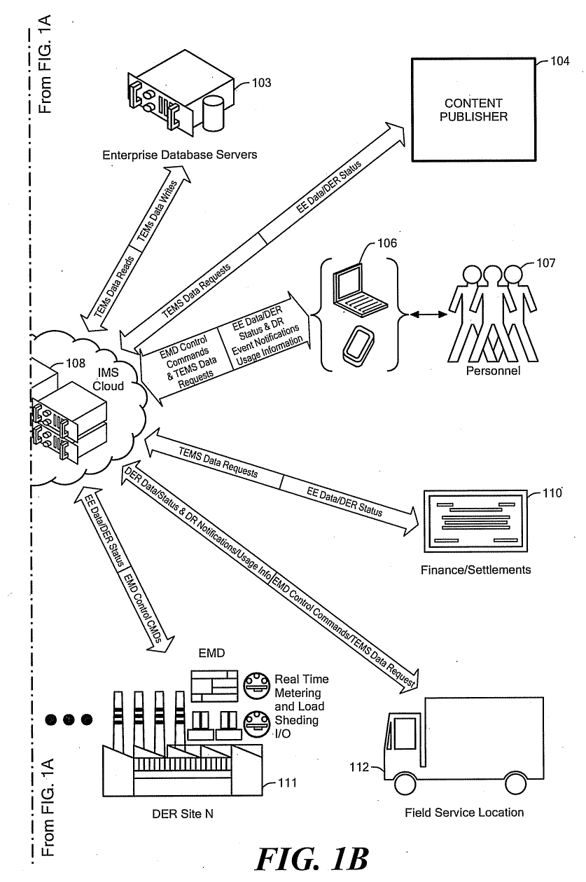

FIG. 1 illustrates a presence based IMS 108 that facilitates presence-based real-time communication that is secure (encrypted) and bi-directional between remote sites for the distribution of energy usage information as well as energy management commands. Energy usage information aggregated by a TEMS service provider is useable by TEMS systems for optimization of the allocations of available energy through energy management commands. An IMT presence based data processing and NOC IMC application 105 is vital to energy usage information aggregation as it enables IMT presence based bidirectional machine-to-machine(s) (M2M), machine-to-human(s) (M2H) and human-to-machine(s) (H2M) communication between distributed EMDs at each site 111 and other TEMS system components. The information may be gathered from various sites such as utility/grid operator dispatches 109, metering or monitoring control EMDs 111, any other field service locations 112 or other sites not listed here that make, consume, or distribute energy. The aggregated information is analyzed and reviewed by TEMS system network monitoring and management applications such as PowerTrak 101 and DR event manager and energy analyst personnel 102 in order to issue event notifications and control commands, further data acquisitions and to update EMD configurations. The aggregated information is provided for use on an enterprise database server 103 accessible by certain energy providers or consumers for review and analysis of energy usage by themselves or others, and may also be published to one or more content publishers 104 for further redistribution of information outside the TEMS IMT based communication network. Certain personnel 107 at sites other than those listed may also retrieve energy usage information and issue energy management commands through devices 106, such as mobile phones, computers, or other wireless devices having access to the IMS 108 through the internet. As further illustrated in FIG. 1, aggregated energy usage information may also be utilized by finance sites 110 to facilitate energy purchases and generally govern how a site chooses to make, use, or distribute energy resources.

The foundation of the NOC IMC presence based application 105 may be constructed from IMTs. The Extensible Messaging and Presence Protocol (XMPP) provides an open XML-based protocol for secure, near real-time, and extensible instant messaging and presence information. The XMPP is generally used in messaging clients such as Jabber and is adaptable for use within the communication framework of the current invention as it meets the criteria of IMT previously defined. More information about XMPP may be found at http://xmpp.org/. While Jabber is an example of one application that uses XMPP, there are many other applications that use the protocol. Additionally, other protocols meeting the IMT definition, including proprietary protocols, may be used, created, or adapted to provide the communication abilities required in a NOC IMC presence based application 105 to effectuate the desired network. Using IMT allows the current invention to utilize preexisting readily available internet/intranet networks. The use of IMT, specifically presence messages and IMS maintained presence and roster lists (including Broadcast Services), allows a TEMS service provider to operate a NOC IMC application in order to determine in real-time what DERs are available to participate in DR events. Machines communicate data through the networks using a defined language, typically called a data standard within the IMT protocol. The message data standard employed by one embodiment of the current invention has strict rules defined so that messages can be interpretable by both human and machine, but in other specific embodiments that may not be the case. Conventionally, this data standard does not exist and all messages are ad-hoc and unstructured messages an IMC user has entered and does not have structural rules to facilitate machine understanding of the contained message. The XMPP protocol in and of itself is just a protocol definition that may be implemented to facilitate transfer of the standardized messages over the internet.

Using presence based IMT as the communication framework allows the communication component of framework to be kept separate or abstracted from other TEMS system components 101-104. With an IMS or IMS cluster 108 acting as a separate communication application, no other TEMS system component functions as the communication hub. This provides the TEMS application a desirable common interface between all TEMS system components. The energy usage and management communications of the TEMS application through the presence network may be referred to in this description as PowerTalk.

IMTs are advantageous for optimal management of DERs, which require secure communication with a device at periodic intervals, generally within five minutes or less. Optimal management also requires both the ability to receive encrypted messages from a site about events and event information as well as an ability to confirm receipt of the messages, which can be achieved at real-time rates with the described presence based IMT. Furthermore, the communication framework provided by presence based IMT will allow each party with an IMS account to know in real-time the status of other parties with IMS accounts as illustrated in FIG. 1. In the current invention, presence information is a network status indicator operable to convey the ability and willingness of a potential communication partner to receive and process messages in order to provide DERs. Through knowledge of the ability and willingness of a partner to provide DERs, a NOC can determine in real-time what capacity is available on a given energy network. The NOC can identify in real-time the available DERs and the dispatch capacity of those DERs. The presence information is also publishable and may be used for site performance reviews and customer feedback, which may further remove the burden on NOC operators 102 to determine connectivity issues. Published presence information also allows distributed system wide self-monitoring, thereby providing an adaptable system with self-healing capabilities. Presence information in aggregated assets may be provided to give the “overall” presence of a group or a sub-group. The aggregated presence data allows real-time determination of partial resource availability. Through knowledge of what/who is online and what DERs they are monitoring and/or controlling, proactive blocking of misbehaving or uncooperative sites may be also be implemented to add further security and reliability to the IMT presence based communication for the current invention.

The communication framework provided by specific embodiments of the present invention allows a record to be created and preserved that indicates energy usage patterns and types of usage in time slices and subsections that facilitate alternative usage analysis and comparison of new pricing methods and opportunities on an ongoing basis. Energy network management and monitoring systems, such as a NOC, may use the record to identify alternative approaches to the energy allocations that may yield cost savings and alternative usage and supplier opportunities, thereby opening up alternative opportunities for DER power production such as local power generation that augments primary energy supply flows, establishing a local generation capability which can manage usage below peak usage patterns and load balance within an organization or facility, and can be securely applied in real-time. The aggregation of power usage patterns from multiple sites, divisions, organizations, and groups of organizations provides power usages statistics, time slices, patterns of usage, load balancing options, and other data. Through energy management tools the gathered information may be provided with a common data analysis format enabling efficient aggregation, segmentation, reorganization, time shifting, and other analytical formatting of the information to ease the review and analysis that reveals possible options or alternatives for power energy purchases and allocations. The efficient mode of analysis is due to the centralized messaging severs that are separate from the applications which use them. Each separate application may choose to log in its' data in its' own way; however, since there is a centralized message router, there is the ability to audit all messages regardless of the applications or devices generating them. This would allow compliance with strict auditing rules.

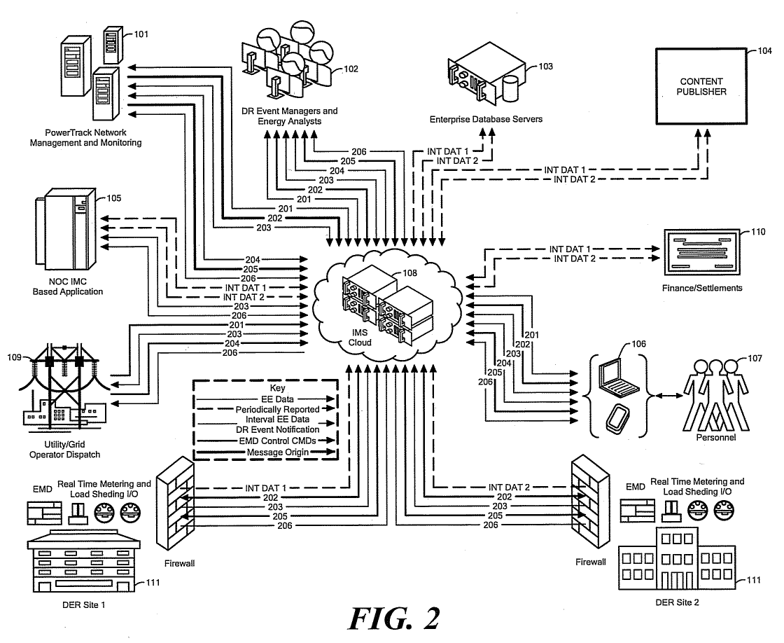

FIG. 2 depicts an example of one scenario in which the system described can be used to aggregate energy usage information under normal conditions as well as conduct a highly automated DR event with a presence based IMS 108 acting as a message router for energy usage and energy management information. Under nominal energy usage conditions, energy usage information (INT DAT 1 and INT DAT 2) is pushed from EMDs at remote DER sites 111 to various components of a TEMS system including NOC IMC presence based applications 105, enterprise database servers 103, content publishers 104, and finance sites 110. Note: the use of Broadcast Services allows a single write be used to deliver messages to all intended readers; for example: a single INT DAT message from a DER to a specific Broadcast Service on the IMS would cause the IMS to deliver the message to multiple targets. A DR event is initiated by a notification message 201 sent from utility or grid operator dispatch clients 109 which provide event parameters. Note: all messages to or from utility or grid operator dispatch may or may not be sent utilizing IMT. The message is disseminated by the IMS 108 to various components of a TEMS system including network management and monitoring applications 101, DR event managers and energy analysts 102, and other personnel 107. Receipt of a notification automatically triggers specific energy management commands 202 to be determined based on the event parameters and issued from network management and monitoring applications 101 to specific EMDs at remote DER sites 111 through the IMS 108. Receipt of an energy management command by an EMD automatically triggers whatever action is specified by the command. For example the energy management command 202 sent to DER Site 1 might prompt the EMD to turn on a generator at that site, while the energy management command 202 sent to DER Site 2 might prompt the EMD to turn off an air conditioning unit. Once an EMD has carried out the specified energy management command, it will send a corresponding response message 203, which often contains energy usage information, to various components of a TEMS system including network management and monitoring applications 101, NOC IMC presence based applications 105, DR event managers and energy analysts 102, and other personnel 107 so that an action may be confirmed or disconfirmed to identify performance problems. For example the energy management command response 203 sent from the EMD at DER Site 1 might indicate the current output of the generator activated at that site, while the energy management command response 203 sent from the EMD at DER Site 2 might indicate the current usage for the site with the air conditioning unit turned off. Further notifications 204 may be sent from utility or grid operator dispatchers 109 to signal changes to the parameters of an existing event or call additional ones. As with the previous notification, receipt of a notification automatically triggers specific energy management commands 205, which are determined based on the notification parameters and are issued from network management and monitoring applications 101 to specific EMDs at remote DER sites 111 through the IMS 108. Receipt of an energy management command by an EMD automatically triggers whatever action is specified by the command. Once an EMD has carried out the specified energy management command, it will send a response message 206, which often contains energy usage information, to various components of a TEMS system. The various components that message 206 may be sent to include the network management and monitoring applications 101, the NOC IMC presence based applications 105, DR event managers and energy analysts 102, and other personnel 107. Accordingly, an action may be confirmed or disconfirmed to identify performance problems.

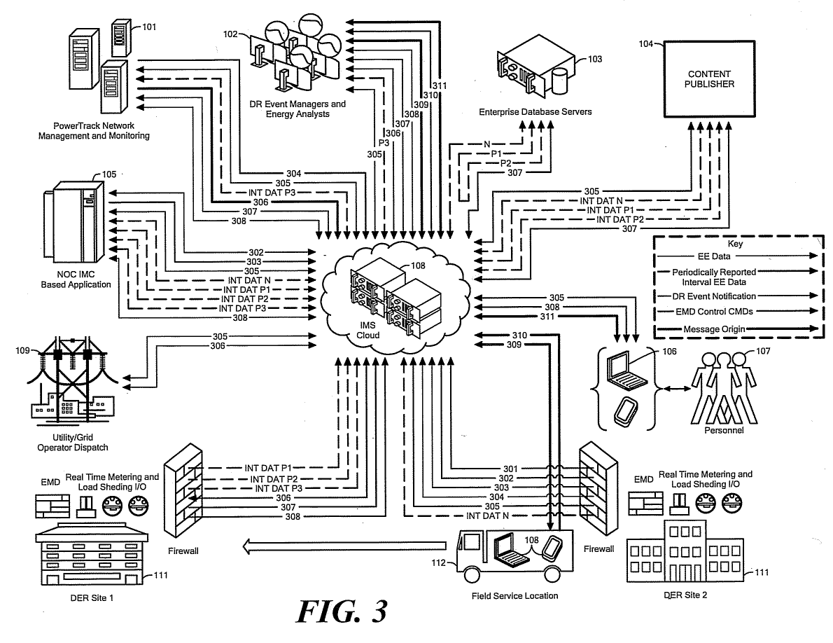

FIG. 3 depicts an example of one operational scenario in which the system described can be used to create and control energy usage information for highly automated DER installation and troubleshooting with a presence based IMS 108 acting as a message router for energy usage and energy management information. New energy usage information is created when a site technician 112 visits a new DER site wishing to participate in a TEMS system. The technician can simply connect an EMD with an embedded IMC to the internet and any desired real-time metering and load shedding energy resources. When the EMD is powered on it will make a secure and encrypted connection 301 to the IMS 108 through which account credentials are verified. Even EMDs on networks behind firewalls should be able to make this connection as it is initiated from the EMD, and is therefore outbound. This connection procedure has the additional benefit of not requiring the technician to work with the IT department of the customer for firewall configuration changes to allow TEMS systems to communicate with the remote distributed energy resource. Next, messages requesting roster and Broadcast Service additions and presence subscriptions 302 and 303 are exchanged between the EMD and IMS 108 and NOC presence IMC based application and EMD 105 respectively. Once these server maintained lists have been updated by the IMCs involved, the appropriate EMD configuration 304 for the site is automatically determined and transmitted from the network management and monitoring client 101 to the EMD, often as a set of files, via the IMS 108. Following configuration, an EMD will send a presence message 305 indicating that it is ready to send energy usage information and receive energy management commands to the IMS 108, which will then broadcast this status to all members subscribed to the EMD's presence by messages 302 and 303. Finally the EMD at the newly added DER site will begin to push energy usage information (INT DAT N), such as data stream and channel, to various TEMS system components such as the NOC IMC based application 105, network management and monitoring applications 101, enterprise database servers 103, and content publishers 103 via the IMS 108 at a periodic interval. This energy usage information is automatically monitored by various TEMS system components such as the NOC IMC based application 105 and network management and monitoring applications 101 to ensure proper site configuration and data quality. Meanwhile, a previously installed EMD at a nearby DER site begins to experience problems. Normal energy usage interval data is being pushed from the EMD to the TEMS system (INT DAT P1 and INT DAT P2) until a message that is missing an expected piece of data (INT DAT P3) is eventually received. A network management and monitoring application 101 automatically detects this error and issues an energy management command 306 requesting the missing data to the offending EMD. Receipt of the energy management command prompts the EMD to search for and transmit the missing data 307 to various TEMS system components. Unfortunately the problems at this site become more severe and the next message 308 sent from the distributed EMD is a presence message indicating that the device is no longer online, and can therefore no longer transmit energy usage data or receive energy management commands. This message 309 once received by DR event managers and energy analysts 102 may then be relayed a nearby site technician to inform him/her of the problem. The technician may then proceed to the site. Finally, a NOC personnel informs someone at the problem site that a technician has been sent to troubleshoot their problem. Note: presence messages from EMDs at DER sites may also be transmitted to utility and grid operator dispatches to inform them in near real-time of changes to the amount of energy a TEMS system can generate and/or curtail.

The presence based NOC IMC application used in the current invention allows a network of distributed EMDs to be created over the internet. Leveraging presence IMT enables streamlined communication of DR and TEMS devices with a NOC and allows all participants to dynamically react to changes in a given energy network. Within the network an IMC may be allowed to subscribe to the presence of other IMCs so that the IMS notifies the IMC whenever changes occur to the network status of other IMCs to which the IMC is subscribed and that information can be acted on accordingly. For example, a NOC subscribes to the presence of every EMD that it manages, so it will always know in real-time the network status of every EMD and DER in a TEMS system. Even more important, the NOC knows the network status of a grid operator or utility. If the grid operator or utility uses an IMT presence based IMC application as their primary means of signaling a DR event, the NOC will always know whether a valid connection is open to that grid operator or utility so that no communication interruptions occur. Conversely, the grid operator or utility may also know the network status of the NOC and or specific DERs. Through this IMS controlled bidirectional presence subscription, loss of either NOC or grid/utility operator IMC connectivity would almost immediately be known to both parties so that secondary means of communication may be used to notify the other party of the problem that needs to be corrected and allow DR events to continue uninterrupted.

If an IMC's status is changed to indicate that it is offline, for example when a NOC is brought down for scheduled maintenance, and another IMC needs to send a message to that IMC, the message is not lost, instead the message can be queued on the IMS and delivered the next time the recipient logs back into the IMS. Even though the TEMS system as a whole may be offline, with this feature, EMDs can continue to send interval data as usual, as if everything was operating normally. Another example of where this is very valuable is during a DR event. If an EMD happened to lose connectivity shortly before or during the start of an event due to a temporary network problem that happened to occur when a NOC was trying to control an EMD, the control message can be queued by the IMS and then delivered immediately after the EMD comes back online so that the site was still able to perform as expected for the remaining duration of the event. In some embodiments of the invention these stored messages may also be purged based on system settings.

Through a presence based IMT network, an energy network monitoring and management application used by a NOC is capable of issuing energy usage commands (including EMD configuration/programming updates), controlling remote distributed energy devices, collecting energy usage information, analyzing the information, notifying its users of upcoming events, comparing energy allocations and rates, iterating the energy allocations, facilitate energy auctions and bids, analyzing those bids and executing the purchase or sale of energy.

The present invention allows the utility, grid operator, energy consumer or consumer groups to communicate, aggregate information, analyze the information, and optimize energy allocations. Such management and optimizations may be presented to users in a format where they can examine these complex profiles. Additionally, other approaches to optimizing energy usage and lowering costs may be facilitated through the proposed invention including, for example, energy auctions.

Specific embodiments of the present invention take advantage of the availability of networks, including the Internet, power grid networks, wireless networks, communicating power meters, telemetry, data storage, machine control, and other technological advances and developments to combine alternative management options and alternative buying opportunities, including capabilities in automatic or semi-automatic procurement of energy where the combinatorial energy usage statistics are used to identify and secure the optimal overall energy supplier contracts and where suppliers cause any of the aforementioned and other capabilities to also identify optimal and most profitable supply and acquisition combinations to optimize for each constituent in the market and for the market overall the analysis, selling and buying and usage of energy.

Embodiments further enable utilities, grid operators, energy providers and consumers to almost instantly communicate multiple fuel pricing models allowing immediate switching of alternate energy sources based on price, time-of-use energy patterns, and combinatorial and analytical comparisons of energy, resulting in optimal operating costs. New capabilities brought about by intelligent metering and communication capabilities such as IMT based presence enable users to share services and resources over a network simply with a standard internet connection. Firewall-friendly access to resources and DERs anywhere on a network simplifies the task of building, maintaining, and altering a network of devices, software and users. Device level intelligence and embedded control and telemetry capabilities in power systems, meters, and at energy consuming devices and systems is enabled thereby allowing these devices to execute predefined actions at certain times and in response to certain conditions. The devices may be configured, programmed and modified via PowerTalk as needed to change the nature of the devices on the network, thus creating an intelligent network whose operations are organized and optimized for reporting, network administration, and cross platform independence (i.e., common computing platform) that optimizes opportunities in the energy market, whether regulated or deregulated. Embodiments also facilitate direct connectivity to provide customer and supplier access to real-time energy information and critical device performance parameters.

Embodiments of the present invention can offer a data collection system which incorporates one or more of the following elements: energy metering, time of usage intervals in increments approaching real-time, sector identification and hierarchical data such as location, division, billing code, type of usage, etc., historical supplier identification and storage of the data to allow iterative combinations and recombination of these data. Such combination offer exploration, visualization, iteration, optimization, what-if scenario analysis, and other manipulation of the data to record in order to understand, analyze and create bids for the acquisition or sale of energy and to provide enhanced combinatorial and analytical comparisons using the acquired data, to allow for network connectivity of energy measuring devices, to allow for control of energy consuming devices, so as to optimize usage patterns such as shutting down non-essential equipment during peak usage hours to stay under certain critical usage parameters as may optimize acquisition cost, to acquire, store, and aggregate energy usage data ordinarily not stored, or when stored, stored onboard the metering device or usage system, and to enable the information to be downloaded to a computer and evaluated in near real-time or at a later time.

Embodiments may also provide an automated method of collecting, analyzing, grouping, reorganizing, optimizing, messaging, notification, and procuring energy usage data for optimizing energy use and acquisition costs. This may also assist in the collection and organizing of energy usage by timeframe and physical location thereby enabling iteration, reconfiguration, visualization, subgroup classification, load balancing, and other approaches that optimize usage and lower cost.

Although the foregoing provides discussion in terms of an arrangement based on a NOC or centralized point of control, collection, etc., but this is not needed because a distributed protocol supports facility distributed management. For example, an electric utility grid could proxy all commands through a NOC or could directly send commands the EMDs. Similarly, EMDs could send energy usage data to a centralized point of control or to a plurality of distributed decentralized data processing and network control applications.

Embodiments of the present invention may be implemented in any conventional computer programming language. For example, preferred embodiments may be implemented in a procedural programming language (e.g. “C”) or an object oriented programming language (e.g., “C++”, Python, Java). Alternative embodiments of the invention may be implemented as pre-programmed or embedded hardware elements, other related components, or as a combination of hardware and software components.

Embodiments may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures, operating systems, or IMT and data protocols. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software or embedded software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of real time communication in a network of distributed energy resource management devices (EMDs), the method comprising:
establishing presence-based real time communications between at least one distributed energy resource management device (EMD) connected to an electric utility grid and a network operations center (NOC) application.

2. A method according to claim 1, wherein the presence-based real time communications are based on instant messaging technology.

3. A method according to claim 2, wherein the instant messaging technology uses Extensible Messaging and Presence Protocol (XMPP).

4. A method according to claim 1, wherein the presence-based real time communications include energy management communications.

5. A method according to claim 4, wherein the energy management communications include at least one of control commands, data acquisition, data reporting, event notification, energy procurement, and EMD control commands.

6. A method according to claim 5, wherein EMD control commands include at least one of configuration changes, programming updates, and distributed energy resource (DER) control commands.

7. A method according to claim 5, wherein the acquired data is aggregated and analyzed to facilitate ongoing optimization of energy use and cost.

8. A method according to claim 1, wherein the EMD is a distributed generation (DG) device.

9. A method according to claim 1, wherein the at least one EMD is a plurality of EMDs.

10. A system for real time communication in a network of distributed energy resource management devices (EMDs), the system comprising:
a plurality of distributed energy resource management devices (EMDs) connected to an electric utility grid; and
a network operations center (NOC) application having presence-based real time communications with the EMDs.

11. A system according to claim 10, wherein the presence-based real time communications are based on instant messaging technology.

12. A system according to claim 11, wherein the instant messaging technology uses Extensible Messaging and Presence Protocol (XMPP).

13. A system according to claim 10, wherein the presence-based real time communications include energy management communications.

14. A system according to claim 13, wherein the energy management communications include at least one of control commands, data acquisition, data reporting, event notification, energy procurement, and EMD control commands.

15. A system according to claim 14, wherein the acquired data is aggregated and analyzed to facilitate ongoing optimization of energy use and cost.

16. A system according to claim 14, wherein EMD control commands include at least one of configuration changes, programming updates, and distributed energy resource (DER) control commands.

17. A system according to claim 10, wherein the EMD is a distributed generation (DG) device.

18. A communications device for a network of distributed energy resource management devices (EMDs), the communications device comprising:
a local communications client for a distributed EMD connected to an electric utility grid for establishing presence-based real time communications with a network operations center (NOC) application.

19. A device according to claim 18, wherein the presence-based real time communications are based on instant messaging technology.

20. A device according to claim 19, wherein the instant messaging technology uses Extensible Messaging and Presence Protocol (XMPP).

21. A device according to claim 18, wherein the presence-based real time communications include energy management communications.

22. A device according to claim 21, wherein the energy management communications include at least one of control commands, data acquisition, data reporting, event notification, energy procurement, and EMD control commands.

23. A device according to claim 22, wherein EMD control commands include at least one of configuration changes, programming updates, and distributed energy resource (DER) control commands.

24. A device according to claim 22, wherein the acquired data is aggregated and analyzed to facilitate ongoing optimization of energy use and cost.

25. A device according to claim 18, wherein the EMD is a distributed generation (DG) device.
